(19) United States
(12) Patent Application Publication
(10) Pub. No.: US 2013/0002060 A1
(43) Pub. Date: Jan. 3, 2013

(54) STATOR

(75) Inventors: Torben MOLLER, Silkeborg (DK); Kjeld Hellegaard, Bjerringbro (DK)

(73) Assignee: GRUNDFOS HOLDING A/S, Bjerringbro (DK)

(21) Appl. No.: 13/535,662

(22) Filed: Jun. 28, 2012

(30) Foreign Application Priority Data
Jun. 29, 2011 (EP) 11 005 300.6

(51) Int. Cl. H02K 3/34; H02K 15/02; H02K 1/16

(52) U.S. Cl. 310/43; 310/216.108; 29/596

(57) ABSTRACT

The stator of an electric motor includes a stator lamination bundle which is provided with windings which pass through this and which in the regions projecting beyond the stator lamination bundle form end-windings. An end-winding shielding which is electrically conductively connected to the stator lamination bundle is provided. This shielding is formed by segmented and distanced shielding sections which in each case shield at least one end-winding completely or partly.

### BACKGROUND OF THE INVENTION

The invention relates to an electric motor, in particular to a stator of such an electric motor, as well as to a method for manufacturing such a stator.

With electrical motors, in particular with motors controlled by frequency converter and which are activated at higher frequencies than the mains frequency, it is a known problem that potentials are induced in the rotor, in particular by the end-windings of the stator and these potentials produce currents which are broken down by way of short circuit via the motor shaft and the bearings to the motor housing which are connected thereto. This through-flow of current in the bearing region leads to wear and can lead to a premature failure of the bearings. It is known to completely shield the stator winding with respect to the rotor, in order to avoid this.

Thus it is known from U.S. Pat. No. 5,979,087, to provide the stator grooves or stator slots with an electrically conductive shielding, as well as an electrically conductive shielding in the region of the stator heads, which ensure that such an undesired induction from the stator into the rotor shaft is prevented. The shielding which is provided there in the region of the end-windings consists of a multitude of lamination sections connected to only one ring, in each case for the end-windings at each side, as well as of lamination sections which shield the stator groove to the rotor. The shielding which is described there on the one hand requires much effort with regard to manufacturing technology and on the other hand has the disadvantage that the electrical connection to the stator, which in turn is connected to the motor housing receiving the bearings, is often destroyed and thus is ineffective. Such a shielding however is only effected if the electrical connection to the earthed stator is ensured in a reliable manner and in a manner which is stable over the longer term.

Shield rings known from U.S. Pat. No. 5,821,649 are more favorable as far as this is concerned, and these are mechanically and electrically connected to the stator lamination bundle via clips made of metal. These clips engage into grooves of the stator, in which they are pressed, so that a certain clamping effect sets in. Hereby, contact problems can also occur and the shielding concept which is described there requires some effort with regard to assembly technology, since firstly shield plates for the grooves themselves need to be incorporated and then the clips attached on the shielding ring and for their part anchored in the grooves. Moreover, the design necessitates the shielding being formed after the attachment of the stator windings. Hereby, damage to the windings on account of the sharp-edges lamination parts or clips can easily occur.

### BRIEF SUMMARY OF THE INVENTION

Against this background, it is the object of the invention to improve a stator of the known type, as is known for example from U.S. Pat. No. 5,821,649, with regard to the shielding. Thereby, aspects with regard to manufacturing and assembly technology are to be particularly taken into account. Moreover, an inexpensive method for manufacturing such a stator is to be provided.

The stator according to a preferred embodiment of the invention comprises a stator core which is provided with windings which pass through it and which in the regions projecting beyond the stator core form end-windings, wherein at least one end-winding shielding which is connected to the stator core and is electrically conductive is provided in the region of these end-windings, and according to the invention is formed by segmented and spaced shielding sections which in each case completely or partly shield at least one end-winding.

The stator core is typically designed as a stator lamination bundle, but can also be designed in a different manner, for example as a quasi homogeneous component manufactured in a powdered-metallurgical manner. It is to be understood that when hereinafter one speaks of stator lamination bundle or stator lamination bundle section, a stator core or stator core section constructed in a different manner can also be applied.

The basic concept of the solution according to the invention is thus to do without a closed ring in the region of the end-windings, and instead to provide shielding sections which are segmented and distanced to one another and in each case completely or partly shield at least one end-winding. Basically, one envisages such a segmented shielding section shielding two or more end-windings, i.e., in the deflection region of two or more windings. According to the invention, one however envisages the shielding sections being designed as lamination sections and only one end-winding being assigned to each lamination section shielding this. Thereby, as a rule, it is sufficient for the lamination section which shields the respective end-winding, to cover the region of the end-winding which is directed to the rotor, which is to say the lamination section is slightly larger than the outer contour of the end-winding. Significant advantages with regard to manufacturing and assembly technology result due to the fact that the shielding sections are segmented and distanced from one another, and in particular it is possible with this design to assemble the shielding before the incorporation of the winding. It is also possible to attach such a shielding with a segmented stator and specifically likewise before the attachment of the winding. Such stators are known, for example from European Patent Publication No. EP 1 598 918 A1, which is referred to inasmuch as this is concerned.

Basically, the shielding can be designed in an infinite suitable manner, for example by way of metal particles or metal sections, which are conductively connected to one another and are for example embedded in plastic. However, it is particularly favorable if the shielding sections are designed as lamination sections, since such lamination sections can be manufactured and assembled inexpensively in large scale manufacture. Thereby, according to the invention one preferably envisages each lamination section shielding only one end-winding. This has the advantage that a shielding in the region of the end-windings is only provided where this is indeed actually necessary, and free spaces remain next to these, which simplify the manufacture.

If it is the case of a grooved or slotted stator, according to a further development of the invention, it is advantageous if a shielding section shields not only a winding head, but also at least a part of a stator groove. Such a shielding section can be designed in a simple manner as a single-part lamination section, which is contoured and bent in a suitable manner as is yet described in detail further below.

Thereby, according to a further development of the invention, shielding sections can be provided at both sides of the stator core, in order for example to provide the end-windings with a shielding at both sides of the stator lamination bundle. Usefully, the shielding of the grooves or slots is then also effected in each case by half, proceeding from both sides, wherein the partition can be effected selectively longitudinally or transversely.

If the stator core is formed from annular laminations, which is to say it is not the case of a segmented stator, then according to the invention, it is advantageous to provide shielding sections which are part of an annular lamination lying in or on the stator lamination bundle. Such an annular lamination is then applied onto this stator lamination bundle either at one or as the case may be, both sides of this stator lamination bundle and connected to this or applied into this at both ends, which is to say for example integrated between the respective last and second to last lamination of the stator lamination bundle. The shielding sections are then advantageously formed by way of bending away out of the annular lamination, in particular the shielding sections which serve for shielding the end-windings. Thereby, the bending can be effected before as well as after the assembly on the stator lamination bundle.

If the stator core, thus the stator lamination bundle is constructed from core sections, i.e. then laminated core sections, as is described for example in European Patent Publication No. EP 1 598 918 A1 and which are provided in each case with a winding, then according to a further formation of the invention, it is advantageous to assign at least one shield plate section which is connected to the lamination bundle section, to each lamination bundle section. Such an arrangement has the advantage that the shield plate sections can advantageously be fastened on the two end-sides of the lamination bundle section, before the lamination bundle section is provided with a winding. Alternatively, the assembly can also be effected after joining together the lamination bundle sections.

Advantageously, a shield plate section is designed and arranged such that it comprises a part which lies in or on the lamination bundle section and which is arranged parallel to the laminations of the lamination bundle section, and at least one limb which is bent away from the lying section and which forms a shielding. Such a bent-away limb typically forms a shielding for an end-winding.

According to a further formation of the invention, the shield plate section can advantageously comprise at least one (further) limb which is bent away from the lying part and which is bent away opposite to the direction of the (first) limb forming the end-winding shielding. Such a second limb which is directed to the stator core, thus parallel to the motor axis and advantageously in the installed position is radially distanced to the first limb forming the end-winding shielding, can advantageously be used for fastening as well as for the conductive connection to the stator core, in particular to the stator lamination bundle section, if it is fastened there in a suitably designed groove which is envisaged for this.

According to a further advantageous design of the invention, the shield plate section comprises at least one, preferably two (third and fourth) limbs which are bent away from the lying part and which are bent away opposite to the direction of the limb forming the end-winding shielding from the other (second) limb and as these case are distanced to one another. These (third and fourth) limbs advantageously lie in the same plane as the (first) limb forming the end-winding shielding. They serve for shielding the stator grooves, or, with a segmented stator, intermediate spaces in the stator core which are formed between the segments.

The above limb descriptions (first, second, third, fourth) serve exclusively for a better understanding, but have no significance with regard to function or importance. Thus a design of the shield plate section is conceivable, which only has a first limb forming the end-winding shielding and a further, or example a third limb, is also conceivable.

Although it is particularly important to create a well conductive connection between the shielding and the lamination bundle or lamination bundle section if the shielding is to be earthed via the stator lamination bundle, on the other hand however the winding wire is to be protected from the mostly sharp-edges laminations of the stator lamination bundle or of the shielding. For this, according to a further formation of the invention, at least one insulating mould part is provided, which preferably accommodates the lying part of the shield plate section and insulates the shield plate section as well as a part of the stator lamination bundle or stator lamination bundle section with respect to the winding. Such a mould part typically consisting of plastic thus represents an insulator as well as also a mechanical protection of the winding from the laminations.

One advantageous design of such a mould part is such that it engages over the shield plate section in a cap-like manner, wherein the latter is inserted into the insulating mould part. Thereby, the engaging-over or overlap does not have to be over the complete periphery, but only in regions, in which the winding also comes into bearing contact. If the shield plate section is insertable into the insulating mould part, then these can both be manufactured inexpensively and only joined at a later stage, which at present is more economical than a peripheral injection of the shield plate section.

In order to ensure a secure fastening of the shield plate section on the stator lamination bundle section or on the stator lamination bundle, advantageously the (third) limb of the shield plate section which engages into a groove is either welded to the stator lamination bundle or to the stator lamination bundle section or is integrated into the groove with a non-positive fit. The latter can be effected for example by way of this limb being designed in an arched manner and being deformed in a manner opposite to its arching after joining from the outside.

The stator according to preferred embodiments of the invention is typically operated with a rotor rotatably mounted therein. The shielding is located between the rotor and the stator. However, it is to be understood that the invention is not limited to this, and the rotor can also be designed surrounding the stator. The shielding is then not located on the radial inner side of the stator, but on its radial outer side.

The method according to preferred embodiments of the invention for manufacturing a stator, with which one or more lamination sections forming a shielding are arranged on the stator core or on core sections, is characterized in that firstly the lamination sections are attached on the core or on the core sections and only afterwards is the winding attached. This has the advantage that the winding is not damaged by the assembly of the shielding. Otherwise, the shield plate section can be connected to the stator lamination bundle or to the stator lamination bundle section in an analogous manner as with the other laminations of this stator lamination bundle or stator lamination bundle section.

The electrically conductive connection to the stator core, in particular to the stator lamination bundle is only to be created if the earthing is effected via the stator lamination bundle. If the earthing for example is effected directly via the motor housing, the shielding can also be directly conductively connected to the motor housing, for example by way of suitable limbs which contact the motor housing when this is put on.

Advantageously with the method according to the invention, the shield plate sections are inserted into insulating mould parts which then can be arranged on the stator core or on stator core sections before the attachment of the windings. These mould parts can thereby not only serve for insulation but also for fixation of the components and they moreover protect the winding from sharp edges, in particular lamination edges.

It is useful to connect the limb of the shield plate section which lies in the groove of the stator lamination bundle section to the stator lamination bundle by way of welding or by way of deformation, in order to ensure a good electrically conductive connection between the shield plate section and the associated stator lamination bundle section. In this manner, not only is a firm connection attained, but also an electrical connection to several laminations is formed.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1a is a perspective view of a stator lamination bundle with laminations arranged at the end sides, for forming a shielding,

FIG. 1b is a perspective cross-sectional view of the stator lamination bundle of FIG. 1a,

FIG. 2a is a perspective view of the stator lamination bundle according to FIG. 1a, with bent shielding sections,

FIG. 2b is a perspective cross-sectional view of the stator lamination bundle of FIG. 2a,

FIG. 3 is a perspective view of a first embodiment of a shield plate section,

FIG. 4 is a perspective view of a second embodiment of a shield plate section,

FIG. 5 is a perspective view of a third embodiment of a shield plate section,

FIG. 6 is a perspective view of shield plate sections of FIG. 3, in a plastic mould part, in each case for the upper and the lower side of a stator lamination bundle section,

FIG. 7 and FIG. 8 are perspective views of the stator lamination bundle sections with shield plate sections with the mould parts represented in FIG. 6,

FIG. 9 is a perspective view of the stator lamination bundle section according to FIG. 8, with a mould part applied in a one-sided manner,

FIG. 10 is a perspective view of a stator lamination bundle section with shield plate sections, which is provided with a shielding, as represented in FIG. 5,

FIGS. 11a-g show method steps for manufacturing the stator lamination bundle sections provided with a shielding, which are represented in FIGS. 7 and 8, and

FIG. 12 is a longitudinal cross-sectional view of the integration of the stator into a motor.

### DETAILED DESCRIPTION OF THE INVENTION

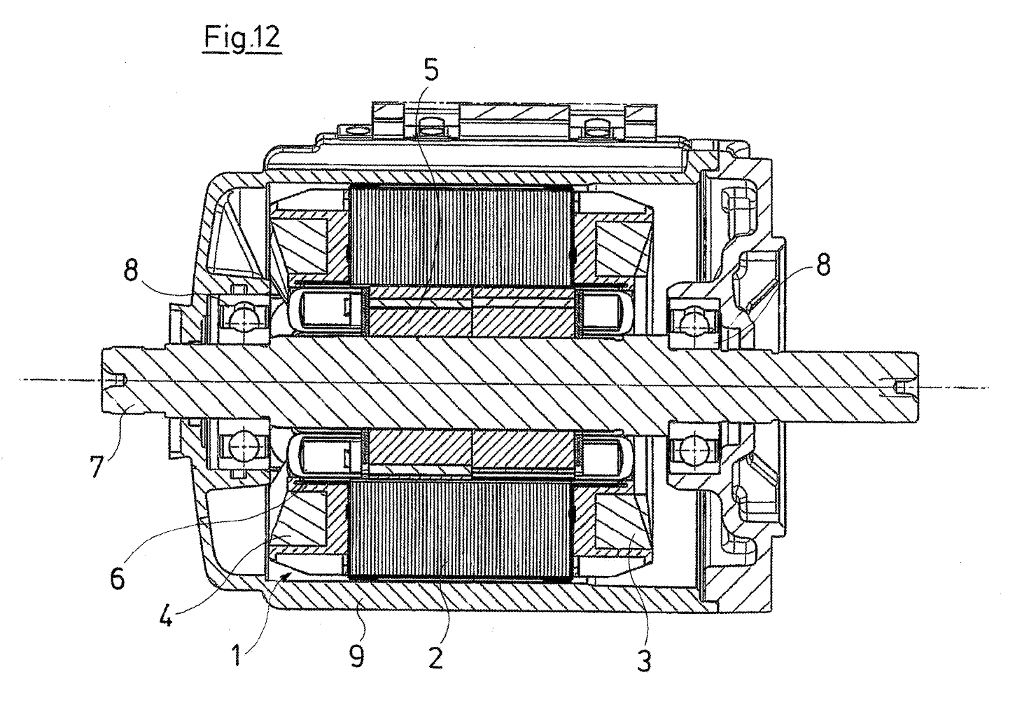

The basic construction of a motor is represented by way of FIG. 12. A stator 1 which forms the stationary part of the motor includes a stator lamination bundle 2, on which windings 3 of the motor are arranged. The motor windings 3 in the regions projecting beyond the stator lamination bundle 2 form end-windings 4 which are shielded with respect to the rotor 5 rotatably mounted within the stator 1, by way of shield plate sections 6 and thus prevent currents from being induced via the stator windings 3 into the shaft 7 of the rotor 5, which would be conducted via bearings 8 in which the shaft 7 is mounted. The shield plate sections 6 are conductively connected to the stator lamination bundle 2 which in turn is conductively connected to the motor housing 9 which is earthed.

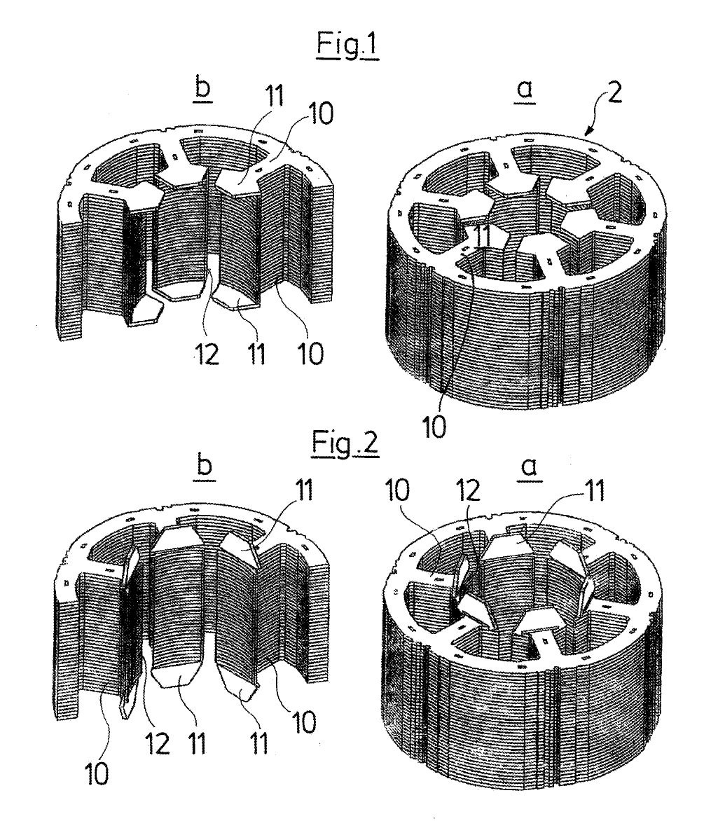

It is represented by way of FIGS. 1 and 2 as to how such shielding sections 6 which are to electromagnetically shield the end-windings 4 with respect to the rotor 5, can be arranged, given a stator lamination bundle 2 constructed of annular stator laminations. With regard to the represented stator lamination bundle 2 it is the case of an annular component which is formed from a multitude of laminations or sheet metal parts which lie on one another, as has been known for some time with stator lamination bundles. The stator lamination bundle 2 on the outside has a closed, essentially cylindrical shape, and in a plan view has radially inwardly directed teeth 10, around which the motor windings not represented in FIGS. 1 and 2 are wound. The uppermost and the lowermost lamination of the stator lamination bundle 2 in FIG. 1 comprise radially inwardly directed lamination sections 11 which are shielding sections and in each case form a later shielding for an end-winding 4. For this, the lamination sections 11, as is evident in FIG. 2, are bent away upwards or downwards by 90°, so that they electromagnetically shield the end-windings 4 with respect to the rotor 5. The lamination sections 11 are segmented and are distanced to one another, which is to say that a separate lamination section 11 is assigned to each end-winding, and a free space is formed between adjacent lamination sections 11 which continues in a groove 12 of the stator lamination bundle 2 which is necessary for being able to attach the winding.

If the stator lamination bundle 2 is not designed as a closed, annular lamination bundle as represented by way of FIGS. 1 and 2, but is to be designed in a segmented manner, which with regard to manufacturing technology is significantly more favorable for attaching the winding, the stator lamination bundle also includes individual segments, so-called stator lamination bundle sections 13 which are provided with shield plate sections, then provided with a winding and only afterwards are joined together into a closed ring, thus into the actual stator, as is described by way of example in European Patent Publication No. EP 1 598 918 A1 which is referred to inasmuch as this is concerned.

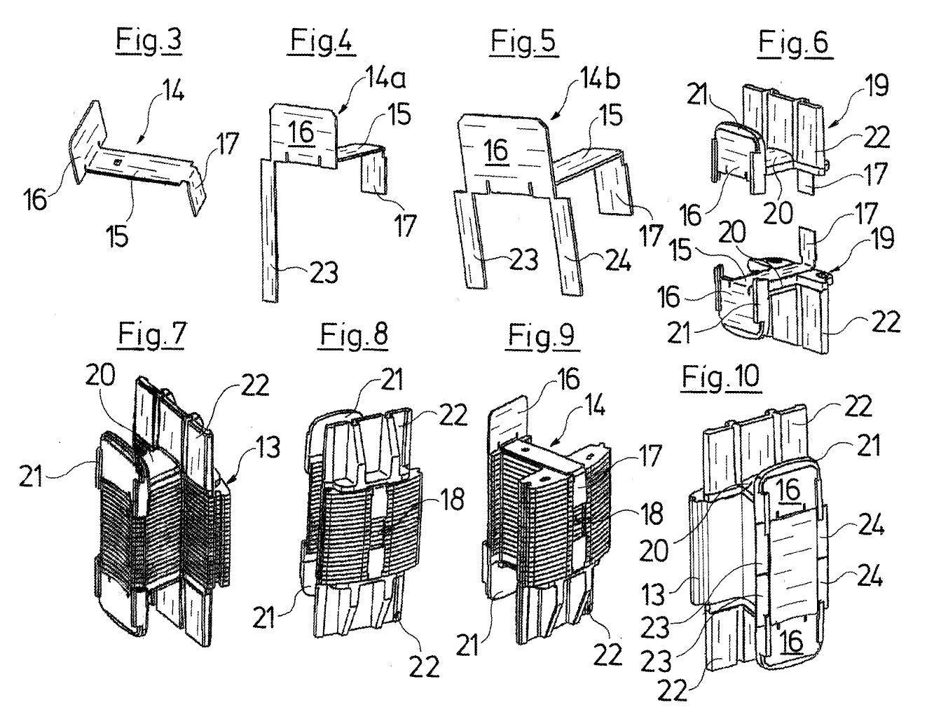

The stator lamination bundle sections 13 likewise consist of a multitude of stator lamination sections which are connected to one another in a manner lying over one another. The uppermost and the lowermost laminations of the stator lamination bundle section 13 are designed as shield plate sections which in the simplest form have a design as is represented by way of FIG. 3. The shield plate section 14 represented there has a lying part 15 which is connected to the stator lamination bundle section 13 quasi as an uppermost or lowermost lamination section and which at its radially inner side in the installed position comprises a first limb 16 which with respect to the stator lamination bundle section 13 is bent by 90° which is to say upwards or downwards in the drawings, from the lying part 15. This first limb 16 in the assembled condition forms a shield section which forms a part of the shielding between the end-windings 4 and the rotor 5.

Furthermore, the shield plate section 14 at another end, thus at the radially outwardly lying end in the installed condition, forms a second limb 17 which is bent away in the direction of the stator lamination bundle section 13, thus in the opposite direction to the first limb 16, and moreover is arranged radially distanced to the first limb 16. This second limb 17 engages into a groove 18 which is on the outer side of the stator lamination bundle section 13 and which forms a part of the later radially outer periphery of the stator lamination bundle. This second limb 17 in particular serves for the electrically conductive connection of the shield plate section 14 to the stator lamination bundle section 13 which for its part is connected in the installed condition to the metallic motor housing which is earthed. In the represented embodiment, the second limb 17 is welded within the groove 18, in order to form an intimate connection to several lamination sections of the stator lamination bundle section 13. Alternatively, the second limb 17 can also be pressed in the groove 18, and for this it has a curvature which follows the curvature of the stator lamination bundle section 13 in this region, but a curvature which is increased and is inwardly deformed by way of tool pressing from the outside radial inwards, by which the second limb 17 is clamped intimately in the sides of the groove 18 and this creates connection which is also electrically well conductive.

An insulating mould part 19 which includes plastic and which is pushed over the shield plate part 14 or into which the shield plate component is integrated, is provided in order to prevent the shield plate section 14 from coming into contact with the later winding. This mould part 19 has an essentially U-shaped shape and a web 20 which insulates the stator lamination bundle section in the figures to the top and to the bottom, with respect to the winding. A limb 21 which is bent away to the outside by 90° with respect to the stator lamination bundle section 13 and which engages over the first limb 16 of the shield plate section 14 at the sides as well as at the flat side directed to the winding, connects to this web 20. A limb 22 connects on the other side of the web 20 and engages over the end-winding radially to the outside and holds it on the stator lamination bundle section 13. In FIG. 9, the upper mould part 19 is shown removed, in order to make it clear as to how the shield plate section 14 is integrated into the mould part 19. The mould part 19 engages over the shield plate section 14 in a cap-like manner and thus forms an electrical insulation with respect to the winding.

A second embodiment of a shield plate section 14a is represented by way of FIG. 4 and comprises a further third limb 23 which continues the first limb 16 via the lying part 15 in the other direction, thus pointing to the stator lamination bundle section 13. This limb 23 forms a shielding in the region of a stator groove, as is represented with the closed stator lamination bundle 2 by way of FIGS. 1 and 2 or the distance between adjacent stator lamination bundle sections. The limb 23 is thus arranged at a radial distance to the limb 17 and parallel to this.

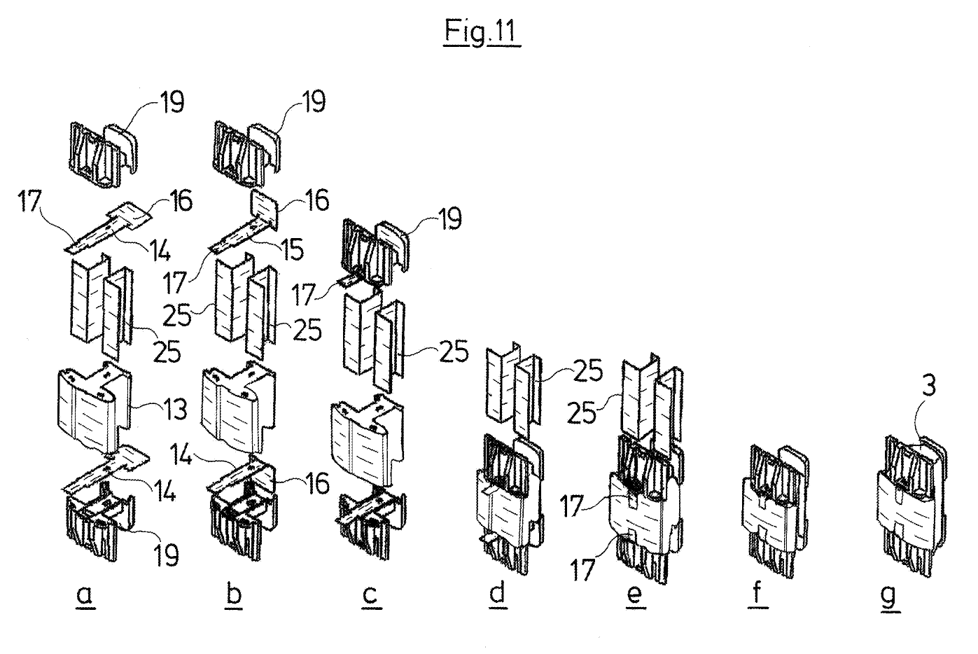

With regard to the shield plate section 14b which is represented in FIG. 5, a further limb 24, a fourth limb is provided, which is distanced from the third limb 23 but lies in the same radial plane and in a plane with the third limb 23 as well as the first limb 16. With this embodiment too, the third and the fourth limb 23 and 24 form groove shieldings, as can be particularly seen in FIG. 10 which shows a stator lamination bundle section 13 with two shield plate sections 14b and covering mould parts 19. As can be clearly recognized there, the limbs 23 and 24 of a shield plate section 14b in each case form a groove shielding over half the height of the stator lamination bundle section 14b. In the installed condition, the limbs 23 and 24 of the adjacent stator lamination bundle section 13 connect to the limbs 23 and 24. Since with this embodiment, the winding is effected before joining the stator lamination bundle sections together into a stator, the limbs 23 and 24 can be designed such that they each in pairs completely cover the groove lying therebehind.

As to how such a stator segment can be manufactured for the application of the previously described components, is described by way of example and by way of FIG. 11.

FIG. 11a firstly shows the applied components in an exploded representation. It is the case of a stator lamination bundle section 13, two shield plate sections 14 which are to be attached on the upper side and lower side of the stator lamination bundle section 13 and are still undeformed in FIG. 11a, the mould parts 19 receiving these, as well as mould parts 25 which are U-shaped in cross section and which are to insulate the winding within the stator lamination bundle section 13 with respect to this. According to FIG. 11b, the first limb 16 forming the later shielding section is bent away from the still flat shield plate section 14 by 90° with respect to the lying part 15. The integration of the shield plate sections 14 bent away of one side, with the first limbs 16 into the respective mould part 19 (FIG. 11c) is then effected. These mould parts 19 then together with the shield plate section 14 integrated therein is connected to the stator lamination bundle section 13 (FIG. 11d), whereupon the second limbs 17 are bent away and integrated and fastened in the groove 18 of the stator lamination bundle section 13, either by way of pressing in or by way of welding (FIG. 11e). Finally, the mould parts 25 are integrated into the stator lamination bundle section 13 (FIG. 11f), whereupon the winding is attached (FIG. 11g) and only thereafter are the stator segments connected into the stator.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A stator of an electric motor with a stator core (2) provided with windings (3) which pass through the stator core (2) and which in the regions projecting beyond the stator core (2) form end-windings (4), with at least one end-winding shielding which is electrically conductively connected to the stator core (2), wherein the shielding is formed by segmented and distanced shielding sections (6, 11, 16) which in each case shield at least one end-winding (4) completely or partly.

2. A stator according to claim 1, wherein the shielding sections (16) are designed as lamination sections (14), wherein each lamination section (14) shields only one end-winding (4).

3. A stator according to claim 1, wherein a shielding section (16, 23, 24) is designed such that it also co-shields at least a part of a stator groove (12).

4. A stator according to claim 1, wherein shielding sections (6, 11, 16) are provided at both sides of the stator core (2).

5. A stator according to claim 1, wherein the stator core (2) is formed as a lamination bundle of annular laminations and that the shielding sections (11) are part of an annular lamination which lies in or on the stator lamination bundle (2).

6. A stator according to claim 5, wherein the shielding sections (11) are formed by way of bending away out of the annular lamination.

7. A stator according to claim 1, wherein the stator core is constructed of core lamination bundle sections (13) which in each case are provided with a winding, and that each core section (13) comprises at least one shield plate section (14) which is connected to the core section.

8. A stator according to claim 7, wherein the shield plate section (14) comprises a part (15) lying in or on the lamination bundle section (13), and at least one limb (16) which is bent away therefrom and which forms a shielding.

9. A stator according to claim 7, wherein the shield plate section (14) comprises at least one limb (17) which is bent away from the lying part (15) and which is bent away opposite to the direction of the limb (16) forming the end-winding shielding.

10. A stator according to claim 9, wherein the shield plate section (14) comprises at least one limb (23, 24) which is bent away from the lying part (15) and is bent away from the other limb (17) opposite to the direction of the limb (16) forming the end-winding shielding and are distanced from one another.

11. A stator according to claim 9, wherein a limb (17) directed to the stator core (2) is provided in a groove (18) provided on the stator laminated core (2) or in the stator core section (14) and via which an electrically conductive connection to the stator core (2) or to a stator core section (14) is formed.

12. A stator according to claim 1, wherein the stator core (2) or a stator core section (14) is provided with at least one insulating mould part (19), which preferably receives the lying part (15) of a shield plate section (14) and insulates the shield plate section (14) as well as a part of the stator core (2) or of a stator core section (14), with respect to the winding.

13. A stator according to claim 12, wherein the insulating mould part (19) engages over the shield plate section (14) in a cap-like manner, and the shield plate section (14) is inserted into the insulating mould part (19).

14. A motor with a stator (2) according to claim 1, wherein it comprises a rotor (5) and that the shielding (6) is arranged on the side of the stator (2) which faces the rotor (5), between the end-winding (4) and the rotor (5) and/or between the stator and rotor.

15. A method for manufacturing a stator, the method comprising:
arranging, on a stator core (2) or on core sections (13), one or more lamination sections forming a shielding; and
attaching one or more windings to the stator core (2) or the core sections (13).

16. A method according to claim 15, with which shield plate sections (14) are inserted into insulating mould parts (19) which are then arranged before the attachment of the windings on the stator core (2) or on the stator core sections (13).

17. A method according to claim 15, with which the shield plate sections (14) with their limbs (17) each lying in a groove (18) on the stator core or stator core section (13) are conductively connected to the stator core or stator core section by way of welding or deforming.
